(19) United States
(12) Patent Application Publication
(10) Pub. No.: US 2007/0056015 A1
(43) Pub. Date: Mar. 8, 2007

(54) System and method of managing IPTV bandwidth in non-observation scenarios

(76) Inventors: Philip Kortum, Houston, TX (US); Marc Sullivan, Austin, TX (US)

Correspondence Address: MATTHEW E. BURR;LAKE AUSTIN MARINA, 2219 WESTLAKE DR, STE 200, AUSTIN, TX, 78746, US

(21) Appl. No.: 11/222,032

(22) Filed: Sep. 8, 2005

(51) Int. Cl. H04N 7/173; H04N 7/16

(52) U.S. Cl. 725/134; 725/109; 725/110; 725/112; 725/142; 725/89

(57) ABSTRACT

Research of television viewing behavior shows that there is a population of television users who tune the television to a particular channel but do not attentively watch the resulting broadcast. In a typical broadcast television system, this poses no additional loads on the system and does not incur additional cost for the content provider. In IPTV, however, these unattended content streams consume valuable bandwidth. A bandwidth management process for television content transmitted via Internet Protocol involves accepting a user designation of identified content as being content that will not be attentively viewed, or that will not be viewed at all during transmission, and reducing the bandwidth for the transmission of the designated content. One approach involves adjusting the video component of the transmitted content to reduce the bandwidth. Another approach involves recording the content to a DVR and automatically playing back the recorded content in a loop.

### FIELD OF THE DISCLOSURE

The present disclosure relates to Internet Protocol television (IPTV), and in particular to methods and machine-readable media to perform the methods for managing the IPTV bandwidth in known non-observation circumstances.

### BACKGROUND

A television may receive programming content through a variety of transmission technologies such as by picking up broadcast radio signals with an antenna or by receiving a transmission through a coaxial cable. In additional to broadcast and cable technologies, the Internet is emerging as a television content transmission medium. Television that receives content through an Internet network connection via the Internet Protocol (IP) may be generically referred to as IPTV.

Television programming content requires a great amount of data, the transmission of which over the Internet demands a large portion of the bandwidth available to a subscriber. The problem is that bandwidth is a precious, substantially fixed, resource and IP Television, due its high volume content, demands a very large amount of the fixed bandwidth that is available to a subscriber household, or that is deliverable by an Internet service provider.

Research that has surveyed the viewing habits of television viewers reveals that a significant number of television users keep the television on, but do not attentively watch the programming. Such television usage in an IPTV environment squanders bandwidth that would otherwise be available to the household for other uses.

There is a need, therefore, for means by which television users are able to reduce the bandwidth utilized by IPTV content transmission when the television is on but unwatched.

### BRIEF DESCRIPTION OF THE DRAWINGS

The present disclosure provides the detailed description that follows, by reference to the noted drawings, by way of non-limiting examples of various embodiments, in which reference numerals represent the same parts throughout the several views of the drawings, and in which:

FIG. 1 is a schematic flow chart of a logic process for a specific exemplary embodiment of a bandwidth management process described herein.

FIG. 2 is a schematic flow chart of a specific exemplary embodiment of a bandwidth management process of the present disclosure.

FIG. 3 is a schematic flow chart of an alternative specific exemplary embodiment of a bandwidth management process of the present disclosure.

FIG. 4 is a diagrammatic illustration of an exemplary embodiment of an on-screen menu of the present disclosure.

FIG. 5 is diagrammatic representation of an exemplary specific alternative embodiment of a system described herein.

FIG. 6 is a diagrammatic representation of a machine in the form of a computer system within which a set of instructions, when executed, may cause the machine to perform any one or more of the methodologies discussed herein.

### DETAILED DESCRIPTION

In view of the foregoing, the present disclosure is intended to bring out one or more of the advantages that will be evident from the description. The present disclosure makes reference to one or more specific embodiments. It is understood that the description of the embodiments is illustrative rather than limiting. The terminology, examples, drawings and embodiments, therefore, are not intended to limit the scope of the claims.

Accordingly, the present disclosure describes systems, methods, and machine-readable media that allow to-the-home bandwidth to be managed in circumstances where it is known to a subscriber that the direct observation of IP television programming is not occurring.

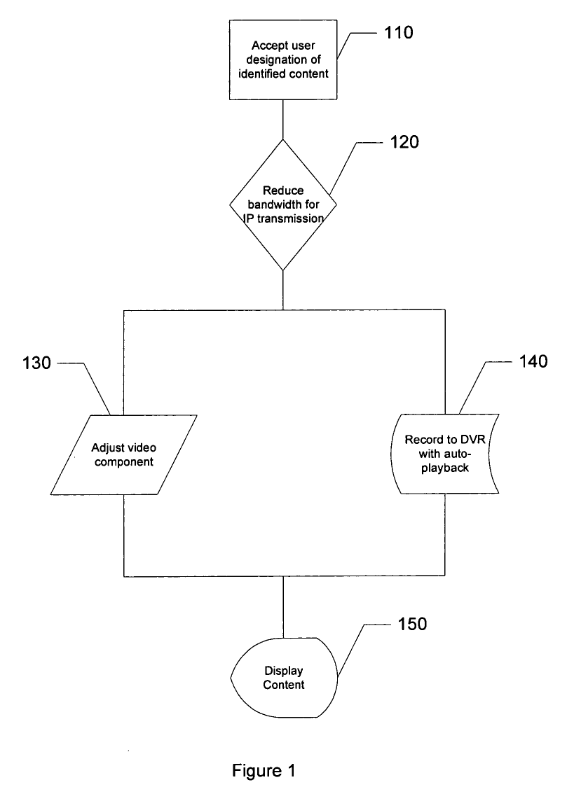

FIG. 1 is a schematic flow chart of a logic process for a specific exemplary embodiment of a bandwidth management process described herein. The first step involves accepting a user designation of identified content 110. For example, a television program is identified and designated by the subscriber as being content that will not be attentively viewed, or that will not be viewed at all, such as for example when the program is transmitted to the home while the subscriber is at work.

The next step involves reducing the bandwidth for the transmission of the user designated identified content at least partially by an Internet Protocol transmission 120. Two approaches for reducing bandwidth are illustrated. One approach involves adjusting the video component of the transmitted content to reduce the bandwidth 130. Another approach involves recording the user designated identified content to, for example, a Digital Video Recorder (DVR) and automatically playing back the recorded content in a loop 140. The content is displayed 150 on a suitable display medium such as a television or computer monitor.

Research of television viewing behavior shows that there is a population of television users who tune the television to a particular channel but do not directly watch the resulting broadcast. In a typical broadcast television system, this poses no additional loads on the system and does not incur additional cost for the content provider. In IPTV, however, these unattended content streams consume valuable bandwidth. The consequence of which is to reduce the content options available in the home. A further consequence is that the costs incurred by the service provider remain higher than would otherwise be necessary.

200 telephone interviews were conducted with cable/satellite TV customers. Three core viewing behaviors were identified from the responses of those surveyed:
1. Session based: watching a specific program (either live or recorded);
2. Surfing: rapidly shifting between channels with brief watching periods; and
3. Backgrounding: keeping the TV on as “company;” not watching continuously, but looking at the TV now and then. Generally, this behavior occurs while the customer is doing other things.

The survey revealed that customers mix these three behaviors. The following discussion examines behavior #3 in more detail, as it is that behavior which creates a significant opportunity to reduce bandwidth usage consumed by IPTV content.

The data indicates that there are two main scenarios in which content is streamed but not directly watched:
1) Customers who use the television as background fill while they perform other tasks. These users are frequently not even in the same room as the television that is being used to display the content; and
2) Customers who use the television to provide stimulation for their pets (particularly dogs) while the customers are away at work.
   The present disclosure provides at least two approaches to reduce the bandwidth consumption for the two scenarios described above.

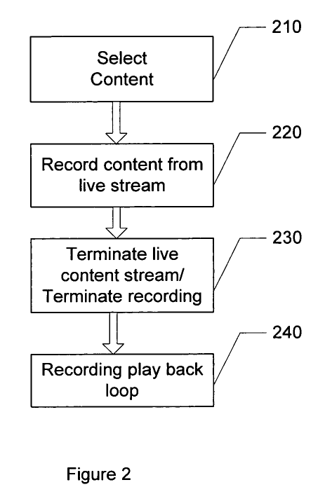

FIG. 2 is a schematic flow chart of a specific exemplary embodiment of a bandwidth managing process of the present disclosure. Approach 1 is illustrated schematically in FIG. 2. In the scenario of FIG. 2, the customer selects 210 a desired program from the on-screen programming menu of the television or tunes to a specific channel that has content for a specific purpose. For example, in the case of the pet stimulation case, the owner could choose to tune to “The Dog Channel”, where content that might be appropriate for the dog (other dogs, lots of movement, soothing voices, and so forth) is found. The content is designated by the user as “background,” or “away” or some other suitable designation that indicates that the recorded content will not be substantially viewed by the user. The designation may be implicit by the act of selecting the specific program. The selected content is streamed to the display, which may or may not be turned on at the time of recording, and is also automatically recorded 220 by the Digital Video Recorder (DVR) of the television set-top box (STB) (also known as a personal video recorder, particularly for satellite STBs) over a given time period (an hour for example). Specific embodiments store the recorded content remotely, such as, for example, in a memory maintained remotely by the IPTV service provider. Other embodiments automatically turn the television display on for playback in the case where the display was turned off during recording.

DVR functionality is well known in the art and typically includes a digital memory that stores recorded content. Another typical feature is that the DVR-capable STB accepts content-recording instructions via a user-operated remote control or other input means (such as STB panel buttons), often by way of a content schedule menu displayed on the television screen that may be navigated with the remote control.

Continuing with the description of approach 1, at the end of the recording time period, the real time signal, and the recording thereof, is terminated 230 and the DVR begins playback of the recorded content in a repeated loop 240. In the case of a typical workday, the content provider saves over 8 hours of streaming bandwidth by using the method of this embodiment.

An alternative embodiment sends “The Dog Channel” content to the DVR during low network usage times and then uses the DVR content when “The Dog Channel” is tuned to in the program guide.” Off-peak downloading may be extended to other types of content to create “virtual” channels that are actually DVR stored content. Low usage times are periods having low bandwidth demand, such as, for example, between midnight and four am.

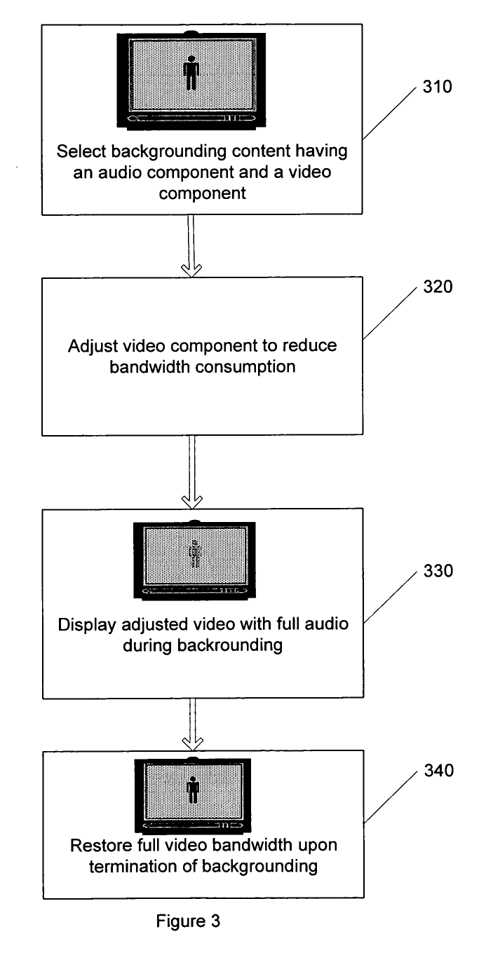

FIG. 3 is a schematic flow chart of an alternative specific exemplary embodiment of a bandwidth managing process of the present disclosure. Approach 2 is illustrated schematically in FIG. 3. In the scenario of FIG. 3, the user tunes to a pre-designated channel, or identifies a channel and designates it, as a ‘background’ channel 310. Any channel on the lineup may be designated as a ‘background’ for a given duration. The identified user designated program content consists of an audio component and video component. With the user designation, the video component of the content is adjusted to reduce the bandwidth of the IP transmitted content. For example, the central office of the service provider adjusts the video stream to reduce the bandwidth required for transmission 320. The television displays video content of reduced bandwidth 330 which may provide an image quality that is noticeably inferior to full spectrum video bandwidth. It is worth noting, however, that substantial gains in available bandwidth may be achieved with very little noticeable degradation of the video image quality.

For example, color depth and resolution are significantly reduced, while maintaining full fidelity sound (since that is the perceptual output that is still be attended to in a background-use situation). In the example of FIG. 3, the user gains back bandwidth for application to other functions contained in an IP enabled home, or if no other functions were occurring then a net bandwidth savings is achieved. The full bandwidth demand of the video component may be restored 340 upon optional termination of the “backgrounding” designation by the subscriber.

In both approaches the user accomplishes the goals they have set, while retaining bandwidth for other home uses. If other home uses are not occurring, then there is a transparent reduction of costs to the service provider. Bandwidth saving in both scenarios is potentially substantial, given the relatively high bandwidth requirements of IP television, particularly for High Definition streams.

Methods for managing bandwidth capacity in a system that receives television content from a content provider via an Internet protocol transmission provide a user interface to designate the selected content that will not be attentively viewed. The user interface may be, for example, a remote control and an on-screen menu display navigable with the remote control. The selected content is highlighted in the menu with a distinctive attribute to indicate the designation of the selected content. The attribute may be a distinctive highlight color, a font change such as bold or underline, flashing the selected content item in the menu, checkerboard or hatch-marked backgrounds, or some other suitable display feature or element to show the designation of the selected content.

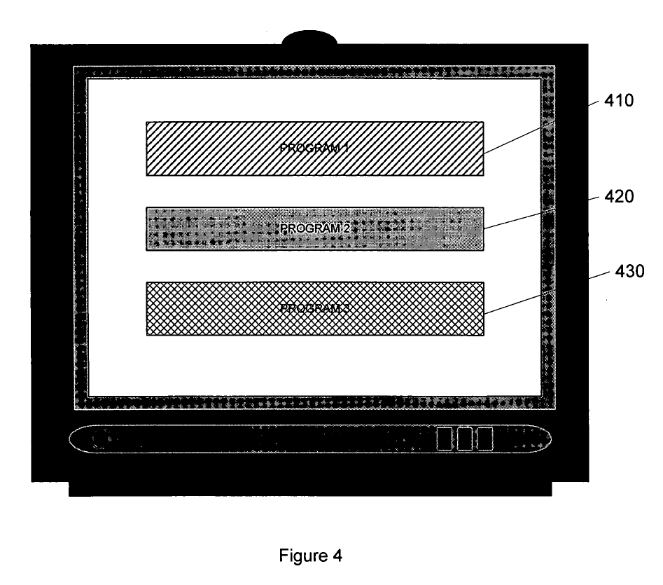

FIG. 4 is a diagrammatic illustration of an exemplary embodiment of an on-screen menu of the present disclosure. Program 1 (410) is presented in the menu display with a slant-hatched background to indicate that it is content for standard DVR recording. Program 2 (420) is presented in the menu display with a solid background to indicate that the content is not selected for any designation. Program 3 (430) is presented in the menu display with cross-hatched background to indicate that the selected content is designated for non-viewing (or non-attentive viewing) bandwidth management as described herein.

Additionally or alternatively, the on-screen menu provides an optionally selectable interactive feature operable with the remote control to designate the selected content. For example, the feature may be an on-screen designator button. That is, a displayed “button” of the type with which any computer user is familiar and uses a mouse to interact with, although here the subscriber uses the remote control to interact with the button. Another example of a feature is an on-screen icon that may be selected with the remote to designate the selected content or which appears on the screen in association with the selected content once the content has been optionally designated by the subscriber.

Further embodiments provide a broadband network for managing bandwidth capacity in a system that receives television content from a content provider via an Internet protocol transmission. The network includes, but is not necessarily limited to a machine-readable medium having instructions stored therein that, when executed by a machine in communication with the network, the instructions cause the machine to perform: accepting a user-designation of selected television content that will not be substantially viewed by the user; and reducing the bandwidth used by the selected content relative to the bandwidth the content would use without the user designation.

Elements of the network may include, but not be limited to, segments of wireless telecom connections and segments of coaxial cable connections for transmission of content to the subscriber. Additionally, the network may include a set-top box device connected to the broadband network and to a television display. The set-top box may include digital video recorder functionality.

The bandwidth reduction a) directly benefits the user, if they want to use the bandwidth for other purposes and b) is essentially transparent to the user in a number of scenarios found to be common in the viewing population.

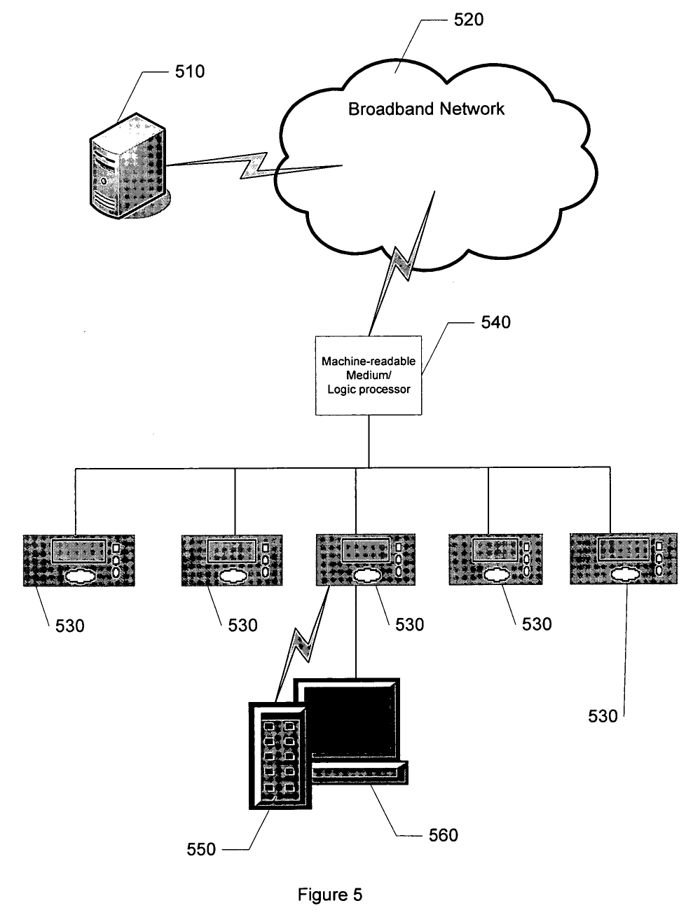

FIG. 5 is diagrammatic representation of an exemplary specific alternative embodiment of a system described herein. Content provider 510 in communication with broadband network 520 provides content via an Internet Protocol transmission to a plurality of set-top box devices 530 which are also in communication with the broadband network. Machine-readable medium 540 accepts commands directly or indirectly from remote control or other input device 550 to designate identified content that will not be substantially viewed to reduce the bandwidth usage of the designated content as described herein. At least one of the set-top box devices 530 is in communication with the machine-readable medium and delivers the identified content to a television or other display device 560 pursuant to the instructions executed by machine-readable medium 540.

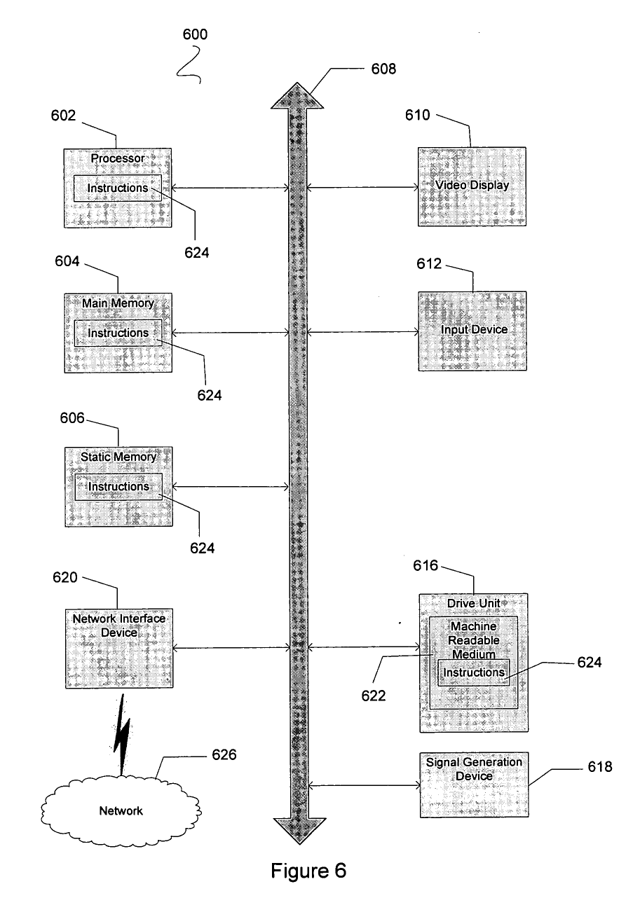

FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a remote control to operate a machine such as, for example, a set-top box device), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, certain of the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

In accordance with various embodiments of the present disclosure, and as mentioned above, certain of the methods described herein are intended for operation as software programs running on a programmable machine such as a computer processor within which a set of instructions, when executed, may cause the machine to perform any one or more of the methodologies discussed herein. The machine may comprise a set-top box (STB) or any machine capable of executing a set of instructions (sequential or otherwise) that specify actions to be taken by that machine. Further, the term “machine” shall also be taken to include any collection of machines, such as, for example the combination of a television display, remote control device, and a set-top box, that individually or jointly execute a set (or multiple sets) of instructions to perform any one or more of the methodologies discussed herein.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems, including set-top box devices. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions or which receives and executes instructions from a propagated signal, so that a device connected to a network environment can send or receive voice, video or data, and to communicate over the network using the instructions. The instructions may further be transmitted or received over a network via a network interface device such as a remote control.

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. The disclosure is considered to include a tangible storage medium or distribution medium, including a propagated signal, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The disclosure has made reference to several exemplary embodiments. It is understood, however, that the words that have been used are words of description and illustration, rather than words of limitation. Changes may be made within the purview of the appended claims, as presently stated and as amended, without departing from the scope and spirit of the disclosure in all its aspects. Although the disclosure has been described with reference to particular means, materials and embodiments, the disclosure is not intended to be limited to the particulars disclosed; rather, the disclosure extends to all functionally equivalent technologies, structures, methods and uses such as are within the scope of the appended claims.

We claim:

1. A machine-readable medium having instructions stored therein that, when executed by a machine for use in connection with content to be communicated via an Internet Protocol transmission, which content uses bandwidth capacity for the Internet Protocol transmission, the instructions cause the machine to perform:
accepting a user designation of identified content that will not be substantially viewed by the user; and
reducing the bandwidth capacity for the Internet Protocol transmission of the identified content relative to the bandwidth capacity that the Internet Protocol transmission of the identified content would use without the user-designation.

2. The medium of claim 1, wherein the instructions cause the machine to reduce the bandwidth capacity by:
recording for a pre-determined amount of time the identified content from an Internet Protocol transmission of a live content stream, wherein recording terminates upon expiration of the pre-determined time;
terminating the Internet Protocol transmission of the live content stream; and
automatically playing back the recorded content in a repeated loop after terminating Internet Protocol transmission of the live content stream.

3. The medium of claim 2, wherein the identified content having the user-designation is automatically recorded periodically.

4. The medium of claim 2, wherein the identified content having the user-designation is automatically recorded during a low bandwidth-demand time and automatically starts play back at a pre-selected time.

5. The medium of claim 4, wherein the low bandwidth-demand time occurs between midnight and four am.

6. The medium of claim 2, wherein the content having the user-designation is recorded by a digital video recorder.

7. The medium of claim 1, wherein the content having the user-designation comprises an audio component and a video component, and wherein the instructions cause the machine to reduce the bandwidth by adjusting the video component of the content to reduce the bandwidth used by the Internet Protocol transmission of the content.

8. The medium of claim 7, wherein the audio component bandwidth remains unchanged.

9. The medium of claim 7, further comprising instructions for a content provider to reduce the bandwidth of the video component of the content.

10. The medium of claim 1, wherein the machine comprises a set-top box device.

11. The medium of claim 10, wherein the set-top box device comprises a digital video recorder.

12. A system for managing bandwidth use in a non-observation circumstance, wherein the system receives content via an Internet Protocol transmission, the system comprising:
A machine-readable medium having instructions stored therein that, when executed by a machine for use in connection with content to be communicated via an Internet Protocol transmission, which content uses bandwidth capacity for the Internet Protocol transmission, the instructions cause the machine to perform:
accepting a user designation of identified content that will not be substantially viewed by the user; and
reducing the bandwidth capacity for the Internet Protocol transmission of the identified content relative to the bandwidth capacity that the Internet Protocol transmission of the identified content would use without the user-designation.

13. The system of claim 12, further comprising a set-top box device connected to a television and to a broadband network.

14. The system of claim 13, wherein the set-top box device is integral with the television.

15. The system of claim 13, wherein the set-top box further comprises a digital video recorder.

16. The system of claim 15, wherein the instructions cause the machine to reduce the bandwidth by:
recording for a pre-determined amount of time the identified content having the user-designation from an Internet Protocol transmission of a live content stream, wherein recording terminates upon expiration of the pre-determined time; and
automatically playing back the recorded content in a repeated loop after termination of the recording.

17. The system of claim 16, wherein the identified content having the user-designation is automatically recorded periodically.

18. The system of claim 12, wherein the identified content comprises an audio component and a video component, and wherein the instructions cause the machine to reduce the bandwidth by adjusting the video component of the idenetified content to reduce the bandwidth used by the Internet Protocol transmission of the identified content.

19. The system of claim 18, further comprising a set-top box connected to a television and to a broadband network.

20. The system of claim 18, further comprising instructions for a content provider to reduce the bandwidth of the video component of the identified content.

21. A broadband network having bandwidth capacity in a system that communicates content from a content provider via an Internet Protocol transmission, the broadband network comprising:
a communication medium to communicate the content having the user-designation to a plurality of set-top box devices, wherein at least one of the set-top box devices comprises a machine-readable medium having instructions stored therein that, when executed by a machine in communication with the at least one set-top box device, the instructions cause the machine to accept a user-designation of identified television content that will not be substantially viewed by the user;
wherein the bandwidth capacity of the communication medium used by the identified content having the user-designation is substantially reduced relative to the bandwidth capacity that the Internet Protocol transmission of the identified content would use without the user-designation.

22. The network of claim 21, wherein the at least one set-top box device further comprises a digital video recorder.

23. The network of claim 22, wherein the digital video recorder:
records for a pre-determined amount of time the identified content having the user-designation from an Internet Protocol transmission of a live content stream, wherein recording terminates upon expiration of the pre-determined time; and
automatically plays back the recorded content on the television in a repeated loop after termination of the recording.

24. The network of claim 23, wherein the identified content having the user-designation is automatically recorded periodically.

25. The network of claim 21, wherein the identified content comprises an audio component and a video component, and wherein the instructions cause the machine to reduce the bandwidth by adjusting the video component of the content having the user-designation to reduce the bandwidth used by the identified content.

26. The network of claim 25, wherein the instructions in the machine-readable medium further comprise instructions for the content provider to reduce the bandwidth capacity of the Internet Protocol transmission of the video component of the identified content.

27. A method for managing bandwidth capacity in a system that receives television content from a content provider via an Internet Protocol transmission, the method comprising:
providing a user interface to identify content for a user-designation that the identified content will not be attentively viewed;
making the the user-designation of the identified content with the user interface; and
reducing the bandwidth capacity for the Internet Protocol transmission of the identified content relative to the bandwidth capacity that the Internet Protocol transmission of the identified content would use without the user-designation.

28. The method of claim 27, wherein the user interface further comprises a remote control and an on-screen menu display navigable with the remote control.

29. The method of claim 28, wherein the selected content is highlighted in the menu with a distinctive attribute to indicate the designation of the identified content.

30. The method of claim 30, wherein the attribute comprises a highlight color.

31. The method of claim 29, wherein the menu comprises an optionally selectable interactive feature operable with the remote control to designate the selected content.

32. The method of claim 31, wherein the feature comprises an on-screen designator button.

33. The method of claim 31, wherein the feature comprises an on-screen icon.

34. The method of claim 27, the method further comprising:
providing a machine-readable medium having instructions stored therein that, when executed by a machine in communication with a machine, the instructions cause the machine to perform:
accepting a user-designation of identified television content that will not be substantially viewed by the user; and
reducing the bandwidth capacity for the Internet Protocol transmission of the identified content having the user-designation relative to the bandwidth capacity that the Internet Protocol transmission of the identified content would use without the user-designation.

35. The method of claim 34, wherein the instructions cause the machine to reduce the bandwidth by:
recording for a pre-determined amount of time the identified content from an Internet Protocol transmission of a live content stream, wherein recording terminates upon expiration of the pre-determined time; and
automatically playing back the recorded content in a repeated loop after termination of the recording.

36. The method of claim 35, wherein the identified content comprises an audio component and a video component, and wherein the instructions cause the machine to reduce the bandwidth by adjusting the video component of the identified content to reduce the bandwidth used by the identified content having the user-designation.

37. The method of claim 36, further comprising instructions for the content provider to reduce the bandwidth of the video component of the identified content having the user-designation.
